(19) United States
(12) Patent Application Publication
(10) Pub. No.: US 2011/0223456 A1
(43) Pub. Date: Sep. 15, 2011

(54) ELECTRODE, SECONDARY BATTERY, AND FABRICATION METHOD OF SECONDARY BATTERY

(76) Inventors: Junichi Sugaya, Osaka (JP); Yoshiyuki Muraoka, Osaka (JP)

(21) Appl. No.: 13/123,866

(22) PCT Filed: Aug. 30, 2010
(86) PCT No.: PCT/JP2010/005320

§ 371 Date: Apr. 12, 2011

(30) Foreign Application Priority Data
Oct. 28, 2009 (JP) 2009247282

(51) Int. Cl. H01M 10/36; H01M 4/139; H01M 10/0587

(52) U.S. Cl. 429/94; 29/623.1; 29/623.5

(57) ABSTRACT

Disclosed is an electrode used in a wound electrode assembly, the electrode including: a current collector; a first material mixture layer including a first active material, which is formed on one surface of the current collector; and a second material mixture layer including a second active material, which is formed on the other surface of the current collector. When an electrode assembly is assembled, the first material mixture layer is wound in a manner such that it is positioned on the outer side of the second material mixture layer. In a part corresponding to a predetermined region of a cross section of said electrode assembly perpendicular to the winding axis thereof, the radius of curvature of the predetermined region being 3.0×10⁻³ m or less, the capacity per unit volume of the first material mixture layer is higher than the capacity per unit volume of the second material mixture layer.

### TECHNICAL FIELD

The present invention relates to a secondary battery including a wound electrode assembly, and particularly relates to improvement of an electrode included in the electrode assembly.

### BACKGROUND ART

Non-aqueous electrolyte secondary batteries with a high energy density, as typified by lithium ion secondary batteries, are used as a power source for portable devices such as personal computers, cell phones, digital cameras, and camcorders.

In a non-aqueous electrolyte secondary battery, an electrode assembly having a folded, stacked, or wound structure is used. Among the above, a wound electrode assembly is common. A wound electrode assembly comprises a positive electrode and a negative electrode spirally wound with a separator interposed therebetween.

Patent Literature 1 proposes making an electrode gradually thicker from the inner side toward the outer side in a wound electrode assembly, so as to improve output characteristics of a battery. This is proposed as allowing bulk densities of material mixture layers to become substantially uniform.

Patent Literature 2 proposes making a material mixture layer disposed on the outer peripheral side of a current collector thicker than a material mixture layer disposed on the inner peripheral side thereof in an electrode comprised in a wound electrode assembly, so as to improve charge and discharge characteristics of a battery. This enables more increase in the active material amount in the material mixture layer on the outer peripheral side, than that in the material mixture layer on the inner peripheral side.

### CITATION LIST

### Patent Literatures

[PTL 1] Japanese Laid-Open Patent Publication No. 2006-12703
[PTL 2] Japanese Laid-Open Patent Publication No. Hei 4-12471

### SUMMARY OF INVENTION

### Technical Problem

In a wound electrode assembly, the radius of curvature of an electrode gradually becomes smaller from the outer side toward the inner side (the closer it is to the winding axis). A part with a smaller radius of curvature has a greater difference in active material density (capacity density) between a material mixture layer on the inner side and a material mixture layer on the outer side, and reactions are prone to becoming non-uniform.

In the method described in Patent Literature 1, reactions are prone to becoming non-uniform since changes are caused in the weight of the material mixture layer (active material), that is, in the capacity density per unit area thereof, on one surface of a current collector.

In the method described in Patent Literature 2, there is a difference in weight of the material mixture layer (active material) between the material mixture layer on the inner side and the material mixture layer on the outer side. Thus, capacity design for the counter electrode becomes complicated, and securing uniformity among electrode reactions becomes difficult.

Therefore, the present invention provides a highly reliable electrode, in which respective capacity densities per unit volume of material mixture layers become uniform when an electrode assembly is assembled, and provides a secondary battery including such electrode. Also, the present invention provides a method for fabricating a secondary battery, the method enabling easy assembling of an electrode assembly including an electrode in which respective capacity densities per volume of material mixture layers are uniform.

### Solution to Problem

The present invention features an electrode used in a wound electrode assembly, the electrode comprising: a current collector; a first material mixture layer comprising a first active material, which is formed on one surface of the current collector; and a second material mixture layer comprising a second active material, which is formed on the other surface of the current collector,

wherein, when an electrode assembly is assembled, the first material mixture layer is wound in a manner such that it is positioned on the outer side of the second material mixture layer, and

a capacity Cᵥ₁ per unit volume of the first material mixture layer is higher than a capacity Cᵥ₂ per unit volume of the second material mixture layer, in a part corresponding to a predetermined region of a cross section of the electrode assembly perpendicular to the winding axis thereof, the radius of curvature of the predetermined region being 3.0×10⁻³ m or less.

The present invention features a secondary battery including a wound electrode assembly in which a pair of electrodes is wound with a separator therebetween,

wherein at least one in the pair of electrodes comprises: a current collector; a first material mixture layer comprising a first active material, which is formed on one surface of the current collector; and a second material mixture layer comprising a second active material, which is formed on the other surface of the current collector,

in the electrode assembly, the first material mixture layer is wound in a manner such that it is positioned on the outer side of the second material mixture layer, and

the ratio of a capacity Cᵥ₁ per unit volume of the first material mixture layer to a capacity Cᵥ₂per unit volume of the second material mixture layer: Cᵥ₁/Cᵥ₂, exceeds 0.97 and is less than 1.03, in a part corresponding to a predetermined region of a cross section of the electrode assembly perpendicular to the winding axis thereof, the radius of curvature of the predetermined region being 3.0×10⁻³ m or less.

A method for fabricating a secondary battery of the present invention includes:

(1) a first step of forming on one surface of a current collector, a first material mixture layer comprising a first active material and forming on the other surface of the current collector, a second material mixture layer comprising a second active material, thereby producing an electrode A having one polarity; and

(2) a second step of winding the electrode A and an electrode B having the other polarity, with a separator interposed therebetween, in a manner such that the first material mixture layer is positioned on the outer side of the second material mixture layer, thereby producing an electrode assembly,

wherein, in the step (1), the electrode A is produced in a manner such that a capacity Cᵥ₁ per unit volume of the first material mixture layer is higher than a capacity Cᵥ₂ per unit volume of the second material mixture layer, in a part corresponding to a predetermined region of a cross section of the electrode assembly perpendicular to the winding axis thereof, the radius of curvature of the predetermined region being 3.0×10⁻³ m or less, and

in the step (2), the electrode assembly is assembled in a manner such that, in the predetermined region, the ratio of the capacity Cᵥ₁ per unit volume of the first material mixture layer to the capacity Cᵥ₂per unit volume of the second material mixture layer: Cᵥ₁/Cᵥ₂, exceeds 0.97 and is less than 1.03.

### Advantageous Effects of Invention

According to the present invention, in the electrode in a wound state due to the constitution of the electrode assembly, the material mixture layer disposed on the inner side of the current collector can be made substantially uniform with the material mixture layer disposed on the outer side of the current collector, in terms of capacity density per unit volume. Thus, electrode reactions in the electrode assembly become uniform, resulting in a secondary battery having excellent charge/discharge cycle characteristics.

While the novel features of the invention are set forth particularly in the appended claims, the invention, both as to organization and content, will be better understood and appreciated, along with other objects and features thereof, from the following detailed description taken in conjunction with the drawings.

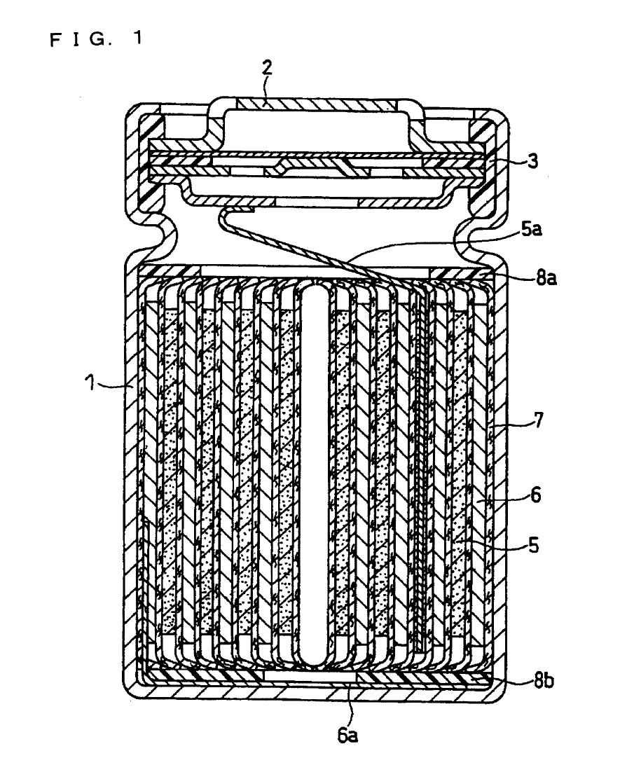

### BRIEF DESCRIPTION OF DRAWING

[FIG. 1] A schematic vertical sectional view of a non-aqueous electrolyte secondary battery which is an example of a secondary battery of the present invention.

### DESCRIPTION OF EMBODIMENT

The present invention relates to an electrode in strip form used in a wound electrode assembly. The electrode comprises: a current collector in strip form; a first material mixture layer comprising a first active material, which is formed on one surface of the current collector; and a second material mixture layer comprising a second active material, which is formed on the other surface of the current collector. When an electrode assembly is assembled, the first material mixture layer is wound in a manner such that it is positioned on the outer side of the second material mixture layer. Also, a capacity Cᵥ₁ (first capacity density) per unit volume of the first material mixture layer is made higher than a capacity Cᵥ₂ (second capacity density) per unit volume of the second material mixture layer, in a part corresponding to a predetermined region (region X) of a cross section of the electrode assembly perpendicular to the winding axis thereof, the radius of curvature of the predetermined region being 3.0×10⁻³ m or less. Note that a capacity per unit volume of a material mixture layer is a capacity (theoretical capacity) equivalent to the amount of an active material included in per unit volume of the material mixture layer. The first active material may be the same as or different from the second active material.

In the case of a conventional electrode in which a first capacity density and a second capacity density are the same, when it is wound, there are instances where a large difference is created between the first capacity density and the second capacity density in the region X and electrode reactions become non-uniform, thereby adversely affecting charge/discharge cycle characteristics.

In contrast, in the electrode of the present invention, the first capacity density is made larger than the second capacity density in the part corresponding to the region X, so as to make the first capacity density substantially the same as the second capacity density when the electrode is wound. In the electrode before winding, the first material mixture layer is a thick layer and the second material mixture layer is a thin layer. When the electrode is wound, compressive stress is generated in the second material mixture layer positioned on the inner side of the current collector, thereby causing a slight increase in its capacity density per unit volume. In contrast, tensile stress is generated in the first material mixture layer positioned on the outer side of the current collector, thereby causing a slight decrease in its capacity density per unit volume. As a result, in the electrode after winding, the first material mixture layer becomes substantially the same as the second material mixture layer in capacity density per unit volume. This enables uniformity in electrode reactions in the electrode assembly, thereby enabling improvement in charge/discharge cycle characteristics of a secondary battery.

In the electrode before winding, in the part corresponding to the region X, the ratio of the capacity Cᵥ₁ per unit volume of the first material mixture layer to the capacity Cᵥ₂ per unit volume of the second material mixture layer: Cᵥ₁/Cᵥ₂, preferably exceeds 1.01 and is 1.05 or less. If Cᵥ₁/Cᵥ₂ exceeds 1.01, the difference between the first capacity density and the second capacity density when the electrode is wound becomes smaller, thereby enabling uniformity in electrode reactions. If Cᵥ₁/Cᵥ₂ exceeds 1.05, the first capacity density becomes considerably larger than the second capacity density even when the electrode is wound, thereby possibly causing non-uniformity in electrode reactions. For more uniformity in electrode reactions, it is more preferable that Cᵥ₁/Cᵥ₂ exceeds 1.01 and is 1.04 or less.

In a part corresponding to a region other than the region X in the electrode before winding, the first capacity density and the second capacity density may be the same, since the difference between the first capacity density and the second capacity density would be smaller therein in the electrode after winding, compared to the part corresponding to the region X. Also, if the first capacity density and the second capacity density would substantially be the same when the electrode assembly is assembled, and if the effect of improved charge/discharge cycle characteristics could be achieved due to uniformity in electrode reactions, then, as in the part corresponding to the region X, the first capacity density may be made larger than the second capacity density in the part corresponding to a region other than the region X.

For example, when the part corresponding to a region other than the region X in the electrode before winding is equivalent to a part corresponding to a region, with a radius of curvature exceeding 3 mm and being 9 mm or less, of a cross section of the electrode assembly perpendicular to the winding axis thereof, then, in that region, the first capacity density and the second capacity density may be the same, or, the first capacity density may be made larger than the second capacity density to the extent that Cᵥ₁/Cᵥ₂ does not exceed 1.05.

To make the first capacity density and the second capacity density substantially the same in the electrode after winding as above, it is preferable to make, in the electrode before winding, the first material mixture layer and the second material mixture layer substantially the same in capacity density per unit area, and the second material mixture layer thicker than the first material mixture layer.

In the part corresponding to the region X in the electrode before winding, the ratio of a capacity Cₐ₁ per unit area of the first material mixture layer to a capacity C_{A2} per unit area of the second material mixture layer: Cₐ₁/Cₐ₂, preferably exceeds 0.97 and is less than 1.03.

The ratio of a thickness T₂ of the second material mixture layer to a thickness T₁ of the first material mixture layer: T₂/T₁, is preferably 1.01 or more and 1.05 or less.

In the part corresponding to the region X in the electrode before winding, if Cₐ₁/Cₐ₂ and T₂/T₁ are within their respective ranges as above, it would become easier to make the first capacity density and the second capacity density substantially the same in the electrode after winding.

The present invention relates to a secondary battery using the above electrode. That is, the secondary battery of the present invention includes an electrode assembly in which a pair of electrodes is wound with a separator interposed therebetween. At least one in the pair of electrodes comprises: a current collector; a first material mixture layer comprising a first active material, which is formed on one surface of the current collector; and a second material mixture layer comprising a second active material, which is formed on the other surface of the current collector. In the electrode assembly, the first material mixture layer is wound in a manner such that it is positioned on the outer side of the second material mixture layer. The ratio of a capacity Cᵥ₁ (first capacity density) per 1 cm³ of the first material mixture layer to a capacity Cᵥ₂ (second capacity density) per 1 cm³ of the second material mixture layer: Cᵥ₁/Cᵥ₂, exceeds 0.97 and is less than 1.03, in a predetermined region (region X) of a cross section of the electrode assembly perpendicular to the winding axis thereof, the radius of curvature of the predetermined region being 3.0×10⁻³ m or less. Preferably, Cᵥ₁/Cᵥ₂ exceeds 0.97 and is less than 1.03 in each electrode of the pair.

When Cᵥ₁/Cᵥ₂ exceeds 0.97 and is less than 1.03 in the electrode assembly of the secondary battery, since the difference between the first capacity density and the second capacity density is small, electrode reactions become uniform, thereby improving charge/discharge cycle characteristics. Cᵥ₁/Cᵥ₂ in the electrode assembly of the secondary battery, is preferably 0.98 or more and 1.02 or less, more preferably 0.99 or more and 1.01 or less, and particularly preferably 1.00.

The secondary battery of the present invention may include an electrode assembly in which a positive electrode and a negative electrode are wound with a separator interposed therebetween, and it may have the form of a cylinder, a prism, a sheet, or the like. Examples of the secondary battery of the present invention include a non-aqueous electrolyte secondary battery and an aqueous electrolyte secondary battery.

A method for fabricating a secondary battery of the present invention includes the steps of:

(1) forming on one surface of a current collector, a first material mixture layer comprising a first active material, and forming on the other surface of the current collector, a second material mixture layer comprising a second active material, thereby producing an electrode A having one polarity; and

(2) winding the electrode A and an electrode B having the other polarity, with a separator interposed therebetween, in a manner such that the first material mixture layer is positioned on the outer side of the second material mixture layer, thereby assembling an electrode assembly.

In the step (1), the electrode A is produced in a manner such that a capacity Cᵥ₁ (first capacity density) per unit volume of the first material mixture layer is made higher than a capacity Cᵥ₂ (second capacity density) per unit volume of the second material mixture layer, in a part corresponding to a predetermined region (region X) of a cross section of the electrode assembly perpendicular to the winding axis thereof, the radius of curvature of the predetermined region being 3.0×10⁻³ m or less.

In the step (2), the electrode assembly is assembled in a manner such that, in the predetermined region (region X), the ratio of the capacity Cᵥ₁ per unit volume of the first material mixture layer to the capacity Cᵥ₂ per unit volume of the second material mixture layer: Cᵥ₁/Cᵥ₂, exceeds 0.97 and is less than 1.03.

By using the electrode A, the electrode assembly with uniform capacity density per unit volume can be easily obtained. Thus, there is uniformity in electrode reactions in the electrode assembly, resulting in a secondary battery having excellent charge/discharge cycle characteristics. To further improve charge/discharge cycle characteristics, it is preferable to produce the electrode B in the same manner as the electrode A. The first capacity density may be made larger than the second capacity density in a part other than the region X also, if the effect of improved charge/discharge cycle characteristics could be achieved due to uniformity in electrode reactions.

The step (1) preferably comprises the steps of:

(a) applying to one surface of the current collector, a first material mixture including the first active material, followed by drying, thereby forming a first coating film;

(b) applying to the other surface of the current collector, a second material mixture including the second active material, followed by drying, thereby forming a second coating film; and

(c) compressing the first coating film and the second coating film by allowing the same pressure to be applied thereon, thereby forming the first material mixture layer and the second material mixture layer, respectively, to obtain the electrode A.

Preferably, in the step (c), an electrode precursor comprising the current collector, first coating film, and second coating film obtained in the steps (a) and (b) is passed through a pair of rollers or pressed with a press machine. Then, the compression ratio of the first coating film is made higher than that of the second coating film, thereby making the first capacity density larger than the second capacity density. The ratio of a compression ratio P2 of the second coating film to a compression ratio P1 of the first coating film: P2/P1, is preferably 0.6 or less and less than 1. Note that a compression ratio is represented by the following equation:

Compression ratio (%)=(Thickness of coating film before compression−Thickness of material mixture layer after compression)/Thickness of coating film before compression×100

A method using two kinds of binders with different elastic moduli can be given, as a first preferred embodiment of the step (1). Specifically, a first binder and a second binder are prepared. For the first binder, a material with an elastic modulus lower than that of the material for the second binder is used. The first binder is added to the first material mixture. The second binder is added to the second material mixture. Note that an elastic modulus is a physical property showing the extent to which a material can resist deformation. The higher the elastic modulus, the more resistant the material is to deformation and the more resistant the material mixture layer is to compression. The ratio of an elastic modulus E1 of the first binder to an elastic modulus E2 of the second binder: E1/E2, is preferably 0.6 or more and 1 or less. Herein, the elastic modulus is referred to as a bending elastic modulus at 20° C.

In the above case, in the step (c), the first coating film is compressed to a greater extent than the second coating film. This is because, during compression, although the same pressure is applied on each side of the current collector, a difference in compression ratio is caused between the material mixture layers due to the respective behaviors of the binders. Thus, in the region X, the electrode A in which the first capacity density is larger than the second capacity density can be easily produced. The elastic modulus of the each binder can be adjusted by, for example, changing the material used for the each binder. To facilitate adjustment of capacity density, preferably used for the first active material is the same material as that for the second active material.

A method using two kinds of active materials with different filling abilities can be given, as a second preferred embodiment of the step (1). Specifically, for the first active material, a material higher in filling ability, that is, higher in tap density, than that of the second active material is used. The ratio of a tap density Td₂ of the second active material to a tap density Td₁ of the first active material: Td₂/Td₁, is preferably 0.6 or more and less than 1.

In the above case, in the step (c), the first coating film is compressed to a greater extent than the second coating film. This is because, during compression, although the same pressure is applied on each side of the current collector, difference in compression ratio is caused between the material mixture layers due to the respective behaviors of the active materials. Thus, in the region X, the electrode A in which the first capacity density is larger than the second capacity density can be easily produced.

The filling ability (tap density) of the each active material can be adjusted by, for example, changing its particle size or shape, or changing the mix ratio of two or more active materials each differing in particle size or shape.

From the aspect of productivity, it is preferable to form the first material mixture layer by applying the first material mixture to one surface of the current collector, entirely, and to form the second material mixture layer by applying the second material mixture to the other surface of the current collector, entirely. Also, one of the first material mixture and the second material mixture may be applied to one surface of apart of the current collector corresponding to the region X, and the other of the first material mixture and the second material mixture may be applied to a part other than the above part.

The method for winding in the step (2) is not particularly limited, as long as, when wound, the positive electrode and the negative electrode are wound in a manner such that the separator is present therebetween.

The method for winding to obtain the electrode assembly in cylindrical form comprises the steps of, for example:

(I) sandwiching two separators with a pair of winding cores;

(II) disposing one of the positive electrode and the negative electrode between the two separators and disposing the other thereof on one of the outer side of the two separators, thereby forming a stack; and

(III) winding the stack by rotating the pair of winding cores, thereby obtaining the electrode assembly.

In this case, the region X is a predetermined region of one of the end portions of the positive electrode in the longitudinal direction thereof, and the predetermined region is a region in close proximity to the central axis of the electrode assembly.

In addition, the electrode assembly in flat oval cylindrical form can be obtained by, for example, pressure-forming into a flat form, the electrode assembly in cylindrical form obtained by the above method. In this case, the region X is present along the longitudinal direction of the positive electrode, at intervals. Those areas are regions corresponding to lateral faces of the electrode assembly, where bent.

In the following, a description will be given on a non-aqueous electrolyte secondary battery, as an embodiment of the present invention.

The non-aqueous electrolyte secondary battery includes a positive electrode, a negative electrode, a separator interposed therebetween, and a non-aqueous electrolyte.

The positive electrode comprises a positive electrode current collector and positive electrode material mixture layers formed on both surfaces of the positive electrode current collector. The thickness of the positive electrode material mixture layer per surface is, for example, 50 to 80 μm. The positive electrode material mixture layer comprises a positive electrode active material and a positive electrode binder, and may further include a positive electrode conductive material as appropriate.

Examples of the positive electrode active material include, for example, a lithium-containing transition metal composite oxide and a transition metal polyanion compound. The positive electrode active material may be of a single material or a combination of two or more materials.

Examples of the lithium-containing transition metal composite oxide include lithium cobaltate (LiCoO₂), lithium nickelate (LiNiO₂), lithium manganate (LiMnO₂, LiMn₂O₄), and modified products thereof. Co, Ni, and Mn in these oxides may be partially substituted with other transition metals, normal metals such as Al, or alkaline-earth metals such as Mg.

Examples of the transition metal polyanion compound include a phosphate compound or sulfate compound having a NASICON or olivine structure and containing a transition metal such as Mn, Fe, Co, and Ni.

The capacity density of the positive electrode can be adjusted by changing the filling ability of the positive electrode active material. The filling ability of the positive electrode active material can be adjusted by changing its particle size or shape, or changing the mix ratio of two or more active materials each differing in particle size or shape.

A powder of a positive electrode active material (first positive electrode active material) with a high filling ability, has, for example, an average particle size of 8 to 20 μm, an average degree of circularity of 0.85 to 1, and a tap density of 2.5 to 3.0 g/cm³. Also, the tap density of the first positive electrode active material can be increased to 3.3 g/cm³, by mixing a positive electrode active material P_{A} with an average particle size of 8 to 20 μm and a positive electrode active material P_{B} with an average particle size of 2 to 5 μm. The weight ratio of the positive electrode active material P_{A} to the positive electrode active material P_{B}:P_{A}/P_{B}, is preferably 9/10 to 60/40.

A powder of a positive electrode active material (second positive electrode active material) with a low filling ability, has, for example, an average particle size of 1 to 12 μm, an average degree of circularity of 0.7 or more and 0.95 or less, and a tap density of 2.0 g/cm³ or more and less than 3.0 g/cm³.

The ratio of an average particle size Ap₁ of the first positive electrode active material to an average particle size Ap₂ of the second positive electrode active material: Ap₁/Ap₂, and the ratio of a degree of circularity Cp₁ of the first positive electrode active material to a degree of circularity Cp₂ of the second positive electrode active material: Cp₁/Cp₂, are respectively 1.0 or more and 1.5 or less, and at least one of Ap₁/Ap₂ and Cp₁/Cp₂ preferably exceeds 1.0.

The positive electrode current collector is preferably metal foil or alloy foil, which is chemically stable within the range of the positive electrode potential.

The positive electrode current collector is preferably aluminum foil or aluminum-alloy foil, aluminum foil being the more preferred. The thickness of the positive electrode current collector is, for example, 5 to 20 μm.

Also, a metal layer which is stable under the positive electrode potential may be formed on a surface of a film substrate varying in material, and the resultant may be used as the current collector. To improve current collectivity, a surface of the current collector may be roughened, or perforations may be provided in the current collector.

Examples of the positive electrode binder include polyvinylidene fluoride (PVDF) and polytetrafluoroethylene (PTFE). The content of the positive electrode binder in the positive electrode material mixture layer is preferably 0.5 to 3 parts by weight per 100 parts by weight of the positive electrode active material.

The capacity density of the positive electrode can be adjusted by changing the material (elastic modulus) of the positive electrode binder. For example, the use of PVDF differing in average molecular weight can be considered. The higher the average molecular weight, the higher the elastic modulus becomes.

In the case of the positive electrode for the non-aqueous electrolyte secondary battery, the positive electrode binder (first binder) with a low elastic modulus preferably has an elastic modulus of 500 MPa or more and less than 800 MPa, and its material is preferably PVDF with an average molecular weight of less than one million. The positive electrode binder (second binder) with a high elastic modulus preferably has an elastic modulus of 800 to 1,100 MPa, and its material is preferably PVDF with an average molecular weight of one million or more.

For the positive electrode conductive material, such that is generally used in non-aqueous electrolyte secondary batteries may be used, and examples include graphite, acetylene black, and ketjen black. The content of the positive electrode conductive material in the positive electrode material mixture layer is preferably 0.5 to 3.0 parts by weight per 100 parts by weight of the positive electrode active material.

In the following, a description will be given on an example of a method for producing a positive electrode for a non-aqueous electrolyte secondary battery.

For example, a positive electrode material mixture in slurry form including a positive electrode active material and a positive electrode binder is prepared and applied to a positive electrode current collector, followed by drying, thereby forming a coating film. This coating film is compressed, thereby forming a positive electrode material mixture layer.

The positive electrode material mixture is prepared by, for example, mixing the positive electrode active material and the positive electrode binder, together with an appropriate dispersant. As the dispersant, for example, an organic solvent such as N-methyl-2-pyrrolidone (NMP) or water is used. A positive electrode material such as a conductive material may be further added to the positive electrode material mixture. An additive such as a surfactant may also be added, to improve stability of the positive electrode material mixture and dispersibility of the active material, etc.

The negative electrode comprises a negative electrode current collector and negative electrode material mixture layers formed on both surfaces of the negative electrode current collector. The thickness of the negative electrode material mixture layer per surface is, for example, 60 to 90 μm. The negative electrode material mixture layer comprises a negative electrode active material and a negative electrode binder.

Examples of the negative electrode active material include a carbon material capable of absorbing and desorbing lithium ions and an alloy-formable active material. Examples of the carbon material include natural graphite, artificial graphite, petroleum coke, carbon fiber, a baked product of an organic polymer, carbon nanotube, and carbon nanohorn. Examples of the alloy-formable active material include a metal oxide such as a silicon oxide and a tin oxide, a silicon compound, and a tin compound.

The capacity density of the negative electrode can be adjusted by changing the filling ability of the negative electrode active material. The filling ability of the negative electrode active material can be adjusted by changing its particle size or shape, or changing the mix ratio of two or more active materials each differing in particle size or shape.

A powder of a negative electrode active material (first negative electrode active material) with a high filling ability has, for example, an average particle size of 10 to 20 μm, an average degree of circularity of 0.85 to 1, and a tap density of 1.2 to 1.5 g/cm³. Also, the tap density of the first negative electrode active material can be increased to 1.8 g/cm³, by mixing a negative electrode active material N_{A} with an average particle size of 10 to 20 μm and a negative electrode active material N_{B} with an average particle size of 1 μm or more and less than 10 μm. The weight ratio of the negative electrode active material N_{A} to the negative electrode active material N_{B}: N_{A}/N_{B}, is preferably 90/10 to 60/40.

A powder of a negative electrode active material (second negative electrode active material) with a low filling ability has, for example, an average particle size of 1 μm or more and 15 μm or less, an average degree of circularity of 0.6 or more and 0.95 or less, and a tap density of 0.8 g/cm³ or more and 1.4 g/cm³ or less.

The ratio of an average particle size An₁ of the first negative electrode active material to an average particle size An₂ of the second negative electrode active material: An₁/An₂, and the ratio of a degree of circularity Cn₁ of the first negative electrode active material to the second negative electrode active material Cn₂: Cn₁/Cn₂, are respectively 1.0 or more and 1.5 or less, and at least one of An₁/An₂ and Cn₁/Cn₂ preferably exceeds 1.0.

The negative electrode binder is not particularly limited, but is preferably a rubber material in particle form, from the aspect of being able to deliver binding properties with only a small amount. The rubber material is preferably a material comprising styrene units and butadiene units, and more preferably a styrene-butadiene copolymer (SBR) or modified products thereof.

When using the rubber material as the negative electrode binder, it is preferably used in a combination with a thickener comprising a water-soluble polymer. The water-soluble polymer is preferably cellulose-based resin, and particularly preferably carboxymethyl cellulose (CMC). Other than the above, PVDF or modified products thereof may also be used as the negative electrode binder.

The negative electrode current collector is, for example, metal foil which is stable within the range of the negative electrode potential, and is preferably copper foil. The thickness of the negative electrode current collector is, for example, 5 to 20 μm. A layer of metal, such as copper, which is stable within the range of the negative electrode potential, may be formed on a surface of a film substrate, and the resultant may be used as the negative electrode current collector. To improve current collectivity, a surface of the negative electrode current collector may be roughened, or perforations may be provided.

In the following, a description will be given on an example of a method for producing a negative electrode for a non-aqueous electrolyte secondary battery.

For example, a negative electrode material mixture in slurry form including a negative electrode active material and a negative electrode binder is prepared and applied to a negative electrode current collector, followed by drying, thereby forming a coating film. This coating film is compressed, thereby forming a negative electrode material mixture layer. The negative electrode material mixture is prepared by, for example, mixing the negative electrode active material and the negative electrode binder, together with an appropriate dispersant. As the dispersant, for example, an organic solvent such as N-methyl-2-pyrrolidone (NMP) or water is used.

The separator for the non-aqueous electrolyte secondary battery is a microporous film or a non-woven fabric. The microporous film or the non-woven fabric is made of a material that is durable in the usage environment of the battery, and has ion permeability and a function to provide insulation between the positive and negative electrodes.

For example, a microporous film made of polyolefin resin is used. Examples of polyolefin resin include polyethylene and polypropylene. The microporous film may be formed of a single layer made of one kind of resin, or multiple layers made of two or more kinds of resin. The microporous film may be made of an inorganic insulating material such as alumina or be made of an inorganic insulating material and resin.

The non-aqueous electrolyte comprises a non-aqueous solvent and a solute dissolved therein. The non-aqueous solvent is not particularly limited, but examples include carbonates, halogenated hydrocarbon, ethers, ketones, nitriles, lactones, and an oxolane compound. The non-aqueous solvent is preferably made of a mixed solvent comprising: a solvent A with a high permittivity, its relative permittivity (20° C.) being 20 or higher; and a solvent B with a low viscosity, its viscosity (25° C.) being 0.001 Pa·s or lower.

Examples of the solvent A with a high permittivity include ethylene carbonate (EC) and propylene carbonate (PC). Examples of the solvent B with a low viscosity include dimethyl carbonate (DMC), diethyl carbonate (DEC), and ethyl methyl carbonate (EMC). Dimethoxyethane (DME), tetrahydrofuran (THF), and γ-butyrolactone (GBL) may also be added to the above solvents A and B.

The solute is inorganic salt, organic salt, or a derivative thereof. Examples of inorganic salt include LiPF₆, LiBF₄, LiClO₄, and LiAsF₆. Examples of organic salt include LiSO₃CF₃, LiC(SO₃CF₃)₂, LiN(SO₃CF₃)₂, LiN(SO₂C₂F₅)₂, and LiN(SO₂CF₃)(SO₂C₄F₉). The concentration of the solute in the non-aqueous electrolyte is usually 0.5 to 2.0 mol/L.

For the purpose of improving non-aqueous electrolyte secondary battery characteristics (improving, for example, storage characteristics, cycle characteristics, and safety), an additive of various kinds may be added to the non-aqueous electrolyte. Examples of such additive include vinylene carbonate (VC), cyclohexyl benzene (CHB), and derivatives thereof.

After the electrode assembly is assembled, a battery is fabricated, for example, by the following steps.

The electrode assembly is housed in a battery case. Used for the battery case is, for example: an aluminum alloy; a nickel-plated iron alloy; or a stack comprising resin of any kind and a metal. The battery case is in the form of, for example, a bottomed cylinder or a bottomed prism.

One end of a positive electrode lead and one end of a negative electrode lead are electrically connected to the positive electrode current collector and the negative electrode current collector, respectively. The other end of the positive electrode lead and the other end of the negative electrode lead are electrically connected to a positive electrode terminal and a negative electrode terminal, respectively. The non-aqueous electrolyte is injected into the battery case. When the battery case is in cylindrical form, it is sealed with a sealing member such as a battery lid.

### EXAMPLES

In the following, Examples of the present invention will be described in detail; however, it should be noted that the present invention is not limited to these Examples.

### Example 1

### (1) Production of Positive Electrode Material Mixture A

Stirred with a double arm kneader, were: a powder of lithium nickelate with an average particle size of 12 μm, an average degree of circularity of 0.95, and a tap density of 2.9 g/cm³, as a positive electrode active material; PVDF (elastic modulus: 700 MPa) with an average molecular weight of 600 thousand as a positive electrode binder A (first binder); acetylene black as a conductive material; and a proper amount of NMP, thereby preparing a positive electrode material mixture A (first material mixture) in slurry form. The weight ratio among the positive electrode active material, the positive electrode binder A, and the conductive material was 100:2:2.

### (2) Production of Positive Electrode Material Mixture B

Stirred with a double arm kneader, were: lithium nickelate same as above as a positive electrode active material; PVDF (elastic modulus: 1,000 MPa) with an average molecular weight of one million as a positive electrode binder B (second binder); acetylene black as a conductive material; and a proper amount of NMP, thereby preparing a positive electrode material mixture B (second material mixture) in slurry form. The weight ratio among the positive electrode active material, the positive electrode binder B, and the conductive material was 100:2:2.

### (3) Production of Positive Electrode

For a positive electrode current collector, a 15 μm-thick aluminum foil was prepared. The positive electrode material mixture A was applied to one surface of the positive electrode current collector, followed by drying, thereby forming a coating film A (thickness: 89 μm). The positive electrode material mixture B was applied to the other surface of the positive electrode current collector, followed by drying, thereby forming a coating film B (thickness: 90 μm). As such, a positive electrode precursor comprising the positive electrode current collector, the coating film A, and the coating film B was obtained.

The positive electrode precursor was compressed with a pair of rollers. That is, the coating film A and the coating film B were compressed by allowing the same pressure (linear pressure: 1.5×10² N/cm) to be applied thereon, thereby forming a material mixture layer A (first material mixture layer) and a material mixture layer B (second material mixture layer), respectively. As such, a positive electrode was obtained. Thereafter, the positive electrode was cut into strip form, to a size capable of being inserted into a battery case of a cylindrical battery (18650 type). Specifically, the measurements of the positive electrode in the longitudinal direction and in width were 660 mm and 55 mm, respectively.

The thickness of the material mixture layer A after compression was 59 μm. The thickness of the material mixture layer B after compression was 60 μm. A capacity (capacity density A1) per unit volume of 1 cm³ of the material mixture layer A after compression, was 630 mAh. A capacity (capacity density B1) per unit volume of 1 cm³ of the material mixture layer B after compression, was 620 mAh. The ratio of the capacity density A1 to the capacity density B1: A1/B1, was 1.016. [0057]

A capacity (capacity density A2) per unit area of 1 cm² of the material mixture layer A, was 3.8 mAh. A capacity (capacity density B2) per unit area of 1 cm² of the material mixture layer B, was 3.8 mAh. Note that, herein, area means an area parallel to the main surface of the current collector. The ratio of the capacity density A2 to the capacity density B2: A2/B2, was 1.00.

### (4) Production of Negative Electrode

Stirred with a double arm kneader, were: 300 g of artificial graphite with an average particle size of 15 μm, an average degree of circularity of 0.95, and a tap density of 1.4 g/cm³, as a negative electrode active material; 7.5 g of “BM-400B (trade name)” (aqueous dispersion including 40 wt % of modified styrene-butadiene copolymer) available from Zeon Corporation, as a negative electrode binder; 3 g of CMC as a thickener; and a proper amount of water, thereby preparing a negative electrode material mixture in slurry form. This negative electrode material mixture was applied to both surfaces of a 10 μm-thick copper foil as a negative electrode current collector, followed by drying, thereby obtaining coating films. These coating films were compressed under a linear pressure of 40 N/cm, thereby forming negative electrode material mixture layers. At this time, the thickness of a negative electrode comprising the negative electrode current collector and the negative electrode material mixture layers formed on both surfaces thereof, was 180 μm. Thereafter, the negative electrode was cut into strip form, to a size capable of being inserted into a battery case of a cylindrical battery (18650 type). Specifically, measurements of the negative electrode in the longitudinal direction and in width were 750 mm and 57 mm, respectively.

### (5) Preparation of Non-Aqueous Electrolyte

LiPF₆, as a solute, was dissolved at a concentration of 1 mol/L in a mixed solvent of EC, DMC, and EMC (volume ratio of 2:3:3), thereby preparing a non-aqueous electrolyte. Three parts by weight of VC was added per 100 parts by weight of the non-aqueous electrolyte.

### (6) Assembling of Test Battery

A 18650-type cylindrical non-aqueous electrolyte secondary battery as illustrated in FIG. 1 was fabricated by the following steps, by using the positive electrode, the negative electrode, and the non-aqueous electrolyte obtained above.

One end of a positive electrode lead 5a was connected to a positive electrode lead-connecting portion of a positive electrode 5. One end of a negative electrode lead 6a was connected to a negative electrode lead-connecting portion of a negative electrode 5. Thereafter, the positive electrode 5 and the negative electrode 6 were wound, with a separator 7 interposed therebetween, thereby assembling an electrode assembly in cylindrical form. For the separator 7, a microporous film (thickness: 15 μm) made of polyethylene resin was used.

More specifically, the electrode assembly was assembled in the following manner.

Winding was conducted with a pair of winding cores at the center, in a manner such that the negative electrode was positioned on an inner side than the positive electrode, in a state where: two separators were sandwiched between the pair of winding cores; the positive electrode was disposed between the two separators; and the negative electrode was disposed on the outer side of one of the two separators. At this time, the positive electrode was disposed in a manner such that the material mixture layer A (first material mixture layer) was positioned on the outer side and the material mixture B (second material mixture layer) was positioned on the inner side.

A cross section of the electrode assembly was subjected to image analysis with use of a scanning electron microscope. A region X (region, with a radius of curvature of 3.0×10⁻³ m or less, of a cross section perpendicular to the winding axis, when the electrode assembly is assembled) in the positive electrode, was a region 10 mm in width, being along the longitudinal direction starting from an end portion of the positive electrode at the winding core side.

The capacity densities A and B in the region X after winding of the positive electrode were obtained from the material mixture layers A and B, respectively, by referring to their respective active material amounts in the region X, and their respective volumes in the region X obtained by image analysis. As a result, the ratio of the capacity density Al to the capacity density B1: A1/B1, after winding of the positive electrode (after the electrode assembly was assembled), was 0.985.

An upper insulating ring 8a and a lower insulating ring 8b were disposed on the upper portion and the lower portion of the above electrode assembly, respectively. The resultant was then housed in a battery case 1 made of stainless steel, having the form of a bottomed cylinder. The other end of the positive electrode lead 5a was welded to the bottom surface of a battery lid 2. The other end of the negative electrode lead 5b was welded to the inner bottom surface of the battery case 1. Next, 5 g of the non-aqueous electrolyte was injected into the battery case 1, and then pressure inside the battery case 1 was reduced to 133 Pa, thereby allowing the non-aqueous electrolyte to be impregnated in the electrode assembly. An opening end portion of the battery case was crimped onto the peripheral edge portion of the battery lid 2, with an insulating packing 3 interposed therebetween, thereby sealing the battery case 1. As such, a cylindrical lithium ion secondary battery (18650 type), 18 mm in diameter and 65 mm in height, was completed.

### Example 2

A positive electrode was produced in the same manner as in Example 1, except for using PVDF (elastic modulus: 500 MPa) with an average molecular weight of 300 thousand as the positive electrode binder A. The thickness of the material mixture layer A after compression was 58 μm. The capacity (capacity density A1) per unit volume of 1 cm³ of the material mixture layer A after compression, was 640 mAh. The ratio of the capacity density A1 to the capacity density B1: A1/B1, before winding of the positive electrode, was 1.032.

Except for using the above positive electrode, an electrode assembly was assembled in the same manner as in Example 1. The ratio of the capacity density A1 to the capacity density B1: A1/B1, after winding of the positive electrode, was 1.00.

Except for using the above electrode assembly, a battery was fabricated in the same manner as in Example 1.

### Example 3

PVDF (elastic modulus: 500 MPa) with an average molecular weight of 300 thousand was used as the positive electrode binder A. PVDF (elastic modulus: 1,100 MPa) with an average molecular weight of 1.2 million was used as the positive electrode binder B. Except for the above, a positive electrode was produced in the same manner as in Example 1.

The thickness of the material mixture layer A after compression was 58 μm. The capacity (capacity density A1) per unit volume of 1 cm³ of the material mixture layer A after compression, was 640 mAh. The thickness of the material mixture layer B after compression was 61 μm. The capacity (capacity density B1) per unit volume of 1 cm³ of the material mixture layer B after compression, was 610 mAh. The ratio of the capacity density A1 to the capacity density B1: A1/B1, before winding of the positive electrode, was 1.049.

Except for using the above positive electrode, an electrode assembly was assembled in the same manner as in Example 1. The ratio of the capacity density A1 to the capacity density B1: A1/B1, after winding of the positive electrode, was 1.025.

Except for using the above electrode assembly, a battery was fabricated in the same manner as in Example 1.

### Comparative Example 1

A battery was fabricated in the same manner as in Example 1, except for using a positive electrode in which the material mixture layer B was formed on both surfaces of the current collector. The ratio of the capacity density A1 and the capacity density B1: A1/B1, before winding of the positive electrode, was 1.00. The ratio of the capacity density A1 and the capacity density B1: A1/B1, after winding of the positive electrode, was 0.97.

### [Charge/Discharge Cycle Test]

For each battery, charge/discharge were repeated 1,000 times under a 25° C. environment, under the conditions below, and discharge capacities at the 1^{st} cycle and the 1,000^{th} cycle were obtained, respectively.

Charge current: 3,000 mA

Discharge current: 3,000 mA

End-of-charge voltage: 4.2 V

End-of-discharge voltage: 2.5 V

Then, the capacity retention rate was obtained by the following equation:

Capacity retention rate (%)=(Discharge capacity at the 1,000^{th} cycle/Discharge capacity at the 1^{st} cycle)×100

Table 1 shows the test results of the above.

TABLE 1

| | A1/B1 | | |
|---|---|---|---|
| | When | When | |
| | electrode | electrode assembly | Capacity |
| | is produced | is assembled | retention |
| | (before winding of | (after winding of | rate |
| | electrode) | electrode) | (%) |
| Comp | 1.000 | 0.970 | 70 |
| Ex. 1 | | | |
| Ex. 1 | 1.016 | 0.985 | 83 |
| Ex. 2 | 1.032 | 1.000 | 86 |
| Ex. 3 | 1.049 | 1.025 | 81 |

The respective batteries of Examples 1 to 3, each in which A1/B1 after winding of the electrode exceeded 0.97 and was less than 1.03, exhibited more uniformity in electrode reactions and more improvement in charge/discharge cycle characteristics, compared to the battery of Comparative Example 1, in which A1/B1 after winding of the electrode was 0.97. The respective batteries of Examples 1 to 2, each in which A1/B1 after winding of the electrode was 0.980 or more and 1.020 or less, exhibited excellent charge/discharge cycle characteristics. In particular, the battery of Example 2, in which A1/B1 after winding of the electrode was 1, exhibited the best charge/discharge cycle characteristics.

Note that, although the electrode of the present invention was used for the positive electrode in each of the present Examples, charge/discharge cycle characteristics would also improve, even in the case where the electrode of the present invention is used for the negative electrode, or for both of the positive electrode and the negative electrode.

### Example 4

Stirred with a double arm kneader, were: a powder of lithium nickelate with an average particle size of 12 μm, an average degree of circularity of 0.95, and a tap density of 2.9 g/cm³, as a positive electrode active material C (first active material); PVDF (elastic modulus: 700 MPa) with an average molecular weight of 600 thousand as a positive electrode binder; acetylene black as a conductive material; and a proper amount of NMP, thereby preparing a positive electrode material mixture C (first material mixture) in slurry form. The weight ratio among the positive electrode active material C, the positive electrode binder, and the conductive material was 100:2:2.

Stirred with a double arm kneader, were: lithium nickelate with an average particle size of 10 μm, an average degree of circularity of 0.80, and a tap density of 2.3 g/cm³, as a positive electrode active material D (second active material); a positive electrode binder and conductive material same as those above; and a proper amount of NMP, thereby preparing a positive electrode material mixture D (second material mixture) in slurry form. The weight ratio among the positive electrode active material D, the positive electrode binder, and the conductive material was 100:2:2.

For a positive electrode current collector, a 15 μm-thick aluminum foil was prepared. The positive electrode material mixture C was applied to one surface of the positive electrode current collector, followed by drying, thereby forming a coating film C (thickness: 89 μm). The positive electrode material mixture D was applied to the other surface of the positive electrode current collector, followed by drying, thereby forming a coating film D (thickness: 91 μm). As such, a positive electrode precursor comprising the positive electrode current collector, the coating film C, and the coating film D was obtained.

The positive electrode precursor was compressed with a pair of rollers. That is, the coating film C and the coating film D were compressed by allowing the same pressure (linear pressure: 1.5×10² N/cm) to be applied thereon, thereby forming a material mixture layer C (first material mixture layer) and a material mixture layer D (second material mixture layer), respectively. As such, a positive electrode was obtained. Thereafter, the positive electrode was cut to a size (measurement in longitudinal direction: 660 mm, measurement in width: 55 mm) capable of being inserted into a battery case of a cylindrical battery (18650 type).

The thickness of the material mixture layer C after compression was 59 μm. The thickness of the material mixture layer D after compression was 61 μm. A capacity (capacity density C1) per unit volume of 1 cm³ of the material mixture layer C after compression, was 640 mAh. A capacity (capacity density D1) per unit volume of 1 cm³ of the material mixture layer D after compression, was 620 mAh. The ratio of the capacity density C1 to the capacity density D1: C1/D1, was 1.032.

A capacity (capacity density C2) per unit area of 1 cm² of the material mixture layer C, was 3.8 mAh. A capacity (capacity density D2) per unit area of 1 cm² of the material mixture layer D, was 3.8 mAh. Note that, herein, area means an area parallel to the main surface of the current collector. The ratio of the capacity density C2 to the capacity density D2: C2/D2, was 1.00.

Except for using the above positive electrode, an electrode assembly was assembled in the same manner as in Example 1.

A region X (region, with a radius of curvature of 3.0×10⁻³ m or less, of a cross section perpendicular to the winding axis, when the electrode assembly is assembled) in the positive electrode, was a region 10 mm in width, being along the longitudinal direction starting from an end portion of the positive electrode at the winding core side.

The capacity densities C1 and D1 in the region X after winding of the positive electrode were obtained from the material mixture layers C and D, respectively, by referring to their respective active material amounts in the region X, and their respective volumes in the region X obtained by image analysis. As a result, the ratio of the capacity density C1 to the capacity density D1: C1/D1, after winding of the positive electrode (after the electrode assembly was assembled), was 1.00.

Except for using the above electrode assembly, a battery was fabricated in the same manner as in Example 1.

### Example 5

Lithium nickelate (tap density: 3.0 g/cm³) resulting from mixing at a 9:1 weight ratio: a powder of lithium nickelate (positive electrode active material P_{A}) with an average particle size of 20 μm and an average degree of circularity of 0.95; and a powder of lithium nickelate (positive electrode active material P_{B}) with an average particle size of 5 μm and an average degree of circularity of 0.95, was used as the positive electrode active material C (first positive electrode active material).

A powder of lithium nickelate with an average particle size of 12 μm, an average degree of circularity of 0.95, and a tap density of 2.9 g/cm³, was used as the positive electrode active material D.

Except for the above, a positive electrode was obtained in the same manner as in Example 4. The thickness of the material mixture layer C after compression was 58 μm. The thickness of the material mixture layer D after compression was 59 μm. The capacity (capacity density C1) per unit volume of 1 m of the material mixture layer C after compression, was 650 mAh. The capacity (capacity density D1) per unit volume of 1 cm³ of the material mixture layer D after compression, was 640 mAh. The ratio of the capacity density C1 to the capacity density D1: C1/D1, before winding of the positive electrode, was 1.017.

Except for using the above positive electrode, an electrode assembly was assembled in the same manner as in Example 4. The ratio of the capacity density C1 to the capacity density D1: C1/D1, after winding of the positive electrode, was 0.980.

Except for using the above electrode assembly, a battery was fabricated in the same manner as in Example 1.

### Example 6

Lithium nickelate (tap density: 3.1 g/cm³) resulting from mixing at a 8:2 weight ratio: the powder of lithium nickelate (positive electrode active material P_{A}) with an average particle size of 20 μm and an average degree of circularity of 0.95; and the powder of lithium nickelate (positive electrode active material P_{B}) with an average particle size of 5 μm and an average degree of circularity of 0.95, was used as the positive electrode active material C (first positive electrode active material). Except for the above, a positive electrode was produced in the same manner as in Example 5.

The thickness of the material mixture layer C after compression was 57 μm. The capacity per unit volume of 1 cm³ of the material mixture layer C after compression, was 660 mAh (capacity density C1). The ratio of the capacity density C1 to the capacity density D1: C1/D1, before winding of the positive electrode, was 1.031.

Except for using the above positive electrode, an electrode assembly was assembled in the same manner as in Example 5. The ratio of the capacity density C1 to the capacity density D1: C1/D1, after winding of the positive electrode, was 1.000.

Except for using the above electrode assembly, a battery was fabricated in the same manner as in Example 1.

### Example 7

Lithium nickelate (tap density: 3.2 g/cm³) resulting from mixing at a 7:3 weight ratio: the powder of lithium nickelate (positive electrode active material P_{A}) with an average particle size of 20 μm and an average degree of circularity of 0.95; and the powder of lithium nickelate (positive electrode active material P_{B}) with an average particle size of 5 μm and an average degree of circularity of 0.95, was used as the positive electrode active material C (first positive electrode active material). Except for the above, a positive electrode was produced in the same manner as in Example 5.

The thickness of the material mixture layer C after compression was 56 μm. The capacity per unit volume of 1 cm³ of the material mixture layer C after compression, was 670 mAh (capacity density C1). The ratio of the capacity density C1 to the capacity density D1: C1/D1, before winding of the positive electrode, was 1.046.

Except for using the above positive electrode, an electrode assembly was assembled in the same manner as in Example 5. The ratio of the capacity density C1 to the capacity density D1: C1/D1, after winding of the positive electrode, was 1.025.

Except for using the above electrode assembly, a battery was fabricated in the same manner as in Example 1.

### Example 8

### (1) Preparation of Positive Electrode Material Mixture C

Stirred with a double arm kneader, were: a powder of lithium nickelate with an average particle size of 12 μm, an average degree of circularity of 0.95, and a tap density of 2.9 g/cm³, using a positive electrode active material C (first positive electrode active material); PVDF (elastic modulus: 700 MPa) with an average molecular weight of 600 thousand as a positive electrode binder; acetylene black as a conductive material; and a proper amount of NMP, thereby preparing a positive electrode material mixture C (first material mixture) in slurry form. The weight ratio among the positive electrode active material C, the positive electrode binder, and the conductive material was 100:2:2. The coating weight for the positive electrode was 0.0200 g/cm².

### (2) Preparation of Positive Electrode Material Mixture D

Stirred with a double arm kneader, were: lithium nickelate with an average particle size of 10 μm, an average degree of circularity of 0.90, and a tap density of 2.7 g/cm³, as a positive electrode active material D (second positive electrode active material); a positive electrode binder and conductive material same as those above; and a proper amount of NMP, thereby preparing a positive electrode material mixture D (second material mixture) in slurry form. The weight ratio among the positive electrode active material D, the positive electrode binder, and the conductive material was 100:2:2. The coating weight for the positive electrode was 0.0206 g/cm².

### (3) Production of Positive Electrode

For a positive electrode current collector, a 15 μm-thick aluminum foil was prepared. The positive electrode material mixture C was applied to one surface of the positive electrode current collector, followed by drying, thereby forming a coating film C (thickness: 89 μm). The positive electrode material mixture D was applied to the other surface of the positive electrode current collector, followed by drying, thereby forming a coating film D (thickness: 91 μm). As such, a positive electrode precursor comprising the positive electrode current collector, the coating film C, and the coating film D was obtained.

The positive electrode precursor was compressed with a pair of rollers. That is, the coating film C and the coating film D were compressed by allowing the same pressure to be applied thereon, thereby forming a material mixture layer C (first material mixture layer) and a material mixture layer D (second material mixture layer), respectively. As such, a positive electrode was obtained. Thereafter, the positive electrode was cut to a size (measurement in longitudinal direction: 660 mm, measurement in width: 55 mm) capable of being inserted into a battery case of a cylindrical battery (18650 type).

The thickness of the material mixture layer C after compression was 59 μm. The thickness of the material mixture layer D after compression was 62 μm. A capacity (capacity density C1) per unit volume of 1 cm³ of the material mixture layer C after compression, was 640 mAh. A capacity (capacity density D1) per unit volume of 1 cm³ of the material mixture layer D after compression, was 630 mAh. The ratio of the capacity density C1 to the capacity density D1: C1/D1, was 1.015.

A capacity (capacity density C2) per unit area of 1 cm² of the material mixture layer C, was 3.8 mAh. A capacity (capacity density D2) per unit area of 1 cm² of the material mixture layer D, was 3.9 mAh. Note that, herein, area means an area parallel to the main surface of the current collector. The ratio of the capacity density C2 to the capacity density D2: C2/D2, was 0.974.

Except for using the above positive electrode, an electrode assembly was assembled in the same manner as in Example 1.

A region X (region, with a radius of curvature of 3.0×10⁻³ m or less, of a cross section perpendicular to the winding axis, when the electrode assembly is assembled) in the positive electrode, was a region 10 mm in width, being along the longitudinal direction starting from an end portion of the positive electrode at the winding core side.

The capacity densities C1 and D1 in the region X after winding of the positive electrode were obtained from the material mixture layers C and D, respectively, by referring to their respective active material amounts in the region X, and their respective volumes in the region X obtained by image analysis. As a result, the ratio of the capacity density C1 to the capacity density D1: C1/D1, after winding of the positive electrode (after the electrode assembly was assembled), was 0.985.

Except for using the above electrode assembly, a battery was fabricated in the same manner as in Example 1.

The respective batteries of Examples 4 to 8 were subjected to the same evaluation as above. Table 2 shows the results, together with the result of Comparative Example 1.

TABLE 2

| | C1/D1 | | |
|---|---|---|---|
| | When | When | |
| | electrode | electrode assembly | Capacity |
| | is produced | is assembled | retention |
| | (before winding of | (after winding of | rate |
| | electrode) | electrode) | (%) |
| Comp | 1.000 | 0.970 | 70 |
| Ex. 1 | | | |
| Ex. 4 | 1.032 | 1.000 | 85 |
| Ex. 5 | 1.017 | 0.980 | 81 |
| Ex. 6 | 1.031 | 1.000 | 87 |
| Ex. 7 | 1.046 | 1.025 | 80 |
| Ex. 8 | 1.015 | 0.985 | 82 |

The respective batteries of Examples 4 to 8, each in which C1/D1 after winding of the electrode exceeded 0.97 and was less than 1.03, exhibited more uniformity in electrode reactions and more improvement in charge/discharge cycle characteristics, compared to the battery of Comparative Example 1, in which C1/D1 after winding of the electrode was 0.97. In particular, the respective batteries of Examples 4 and 6, each in which C1/D1 after winding of the electrode was 1, exhibited excellent charge/discharge cycle characteristics.

Note that, although the electrode of the present invention was used for the positive electrode in each of the present Examples, charge/discharge cycle characteristics would also improve, even in the case where the electrode of the present invention is used for the negative electrode, or for both of the positive electrode and the negative electrode.

### Example 9

### (1) Preparation of Negative Electrode Material Mixture E

Stirred with a double arm kneader, were: artificial graphite with an average particle size of 15 μm, an average degree of circularity of 0.95, and a tap density of 1.4 g/cm³, as a negative electrode active material E (first negative electrode active material); SBR as a negative electrode binder; CMC as a thickener; and a proper amount of water, thereby preparing a negative electrode material mixture E (first material mixture) in slurry form. The weight ratio among the negative electrode active material E, the negative electrode binder, and CMC was 100:2.5:1.

### (2) Preparation of Negative Electrode Material Mixture F

Stirred with a double arm kneader, were: artificial graphite with an average particle size of 15 μm, an average degree of circularity of 0.85, and a tap density of 1.2 g/cm³, as a negative electrode active material F (second negative electrode active material); SBR as a negative electrode binder; CMC as a thickener; and a proper amount of water, thereby preparing a negative electrode material mixture E (second material mixture) in slurry form. The weight ratio among the negative electrode active material F, the negative electrode binder, and CMC was 100:2.5:1.

### (3) Production of Negative Electrode

For a negative electrode current collector, a 10 μm-thick copper foil was prepared. The negative electrode material mixture E was applied to one surface of the negative electrode current collector, followed by drying, thereby forming a coating film E (thickness: 101 μm). The negative electrode material mixture F was applied to the other surface of the negative electrode current collector, followed by drying, thereby forming a coating film F (thickness: 106 μm). As such, a negative electrode precursor comprising the negative electrode current collector, the coating film E, and the coating film F was obtained.

The negative electrode precursor was compressed with a pair of rollers. That is, the coating film E and the coating film F were compressed, by allowing the same pressure (linear pressure: 40 N/cm) to be applied thereon, thereby forming a material mixture layer E (first material mixture layer) and a material mixture layer F (second material mixture layer), respectively. As such, a negative electrode was obtained.

Thereafter, the negative electrode was cut to a size (measurement in longitudinal direction: 750 mm, measurement in width: 57 mm) capable of being inserted into a battery case of a cylindrical battery (18650 type).

The thickness of the material mixture layer E after compression was 84 μm. The thickness of the material mixture layer F after compression was 86 μm. A capacity (capacity density E1) per unit volume of 1 cm³ of the material mixture layer E after compression, was 640 mAh. A capacity (capacity density F1) per unit volume of 1 cm³ of the material mixture layer F after compression, was 630 mAh. The ratio of the capacity density El to the capacity density F1: E1/F1, was 1.015.

A capacity (capacity density E2) per unit area of 1 cm² of the material mixture layer E, was 3.8 mAh. A capacity (capacity density F2) per unit area of 1 cm² of the material mixture layer E, was 3.8 mAh. Note that, herein, area means an area parallel to the main surface of the current collector. The ratio of the capacity density E2 to the capacity density F2: E2/F2, was 1.00.

### (4) Production of Positive Electrode

Stirred with a double arm kneader, were: a powder of lithium nickelate with an average particle size of 12 μm, an average degree of circularity of 0.95, and a tap density of 2.9 g/cm³, as a positive electrode active material; PVDF with an average molecular weight of 600 thousand as a positive electrode binder; acetylene black as a conductive material; and a proper amount of NMP, thereby preparing a positive electrode material mixture in slurry form. The weight ratio among the positive electrode active material, the positive electrode binder, and the conductive material was 100:2:2. This positive electrode material mixture was applied to both surfaces of a 15 μm-thick aluminum foil as a positive electrode current collector, followed by drying, thereby obtaining coating films. These coating films were compressed under a linear pressure of 1.5×10² N/cm, thereby forming positive electrode material mixture layers. At this time, the thickness of a positive electrode comprising the positive electrode current collector and the positive electrode material mixture layers formed on both surfaces thereof, was 133 μm. Thereafter, the positive electrode was cut into strip form, to a size capable of being inserted into a battery case of a cylindrical battery (18650 type). Specifically, measurements of the positive electrode in the longitudinal direction and in width were 660 mm and 55 mm, respectively.

### (5) Fabrication of Battery

Except for using the above positive and negative electrodes, an electrode assembly was assembled in the same manner as in Example 1.

A region X (region, with a radius of curvature of 3.0×10⁻³ m or less, of a cross section perpendicular to the winding axis, when the electrode assembly is assembled) in the negative electrode, was a region 10 mm in width, being along the longitudinal direction starting from an end portion of the negative electrode at the winding core side.

The ratio the capacity density E1 to the capacity density F1: E1/F1, after winding of the negative electrode (after the electrode assembly was assembled), was 0.986.

Except for using the above electrode assembly, a battery was fabricated in the same manner as in Example 1.

### Example 10

Stirred with a double arm kneader, were: artificial graphite with an average particle size of 15 μm, an average degree of circularity of 0.95, and a tap density of 1.4 g/cm³, as a negative electrode active material E (first negative electrode active material); SBR as a negative electrode binder; CMC as a thickener; and a proper amount of water, thereby preparing a negative electrode material mixture E (first material mixture) in slurry form. The weight ratio among the negative electrode active material E, the negative electrode binder, and CMC was 100:2.5:1.

Stirred with a double arm kneader, were: artificial graphite with an average particle size of 15 μm, an average degree of circularity of 0.7, and a tap density of 1.0 g/cm³, as a negative electrode active material F (second negative electrode active material); SBR as a negative electrode binder; CMC as a thickener; and a proper amount of water, thereby preparing a negative electrode material mixture E (second material mixture) in slurry form. The weight ratio among the negative electrode active material F, the negative electrode binder, and CMC was 100:2.5:1.

For a negative electrode current collector, a 10 μm-thick copper foil was prepared. The negative electrode material mixture E was applied to one surface of the negative electrode current collector, followed by drying, thereby forming a coating film E (thickness: 101 μm). The negative electrode material mixture F was applied to the other surface of the negative electrode current collector, followed by drying, thereby forming a coating film F (thickness: 108 μm). As such, a negative electrode precursor comprising the negative electrode current collector, the coating film E, and the coating film F was obtained.

The negative electrode precursor was compressed with a pair of rollers. That is, the coating film E and the coating film F were compressed, by allowing the same pressure (linear pressure: 40 N/cm) to be applied thereon, thereby forming a material mixture layer E (first material mixture layer) and a material mixture layer F (second material mixture layer), respectively. As such, a negative electrode was obtained. Thereafter, the negative electrode was cut to a size (measurement in longitudinal direction: 750 mm, measurement in width: 57 mm) capable of being inserted into a battery case of a cylindrical battery (18650 type).

The thickness of the material mixture layer E after compression was 84 μm. The thickness of the material mixture layer F after compression was 87 μm. A capacity (capacity density E1) per unit volume of 1 cm³ of the material mixture layer E after compression, was 640 mAh. A capacity (capacity density F1) per unit volume of 1 cm³ of the material mixture layer F after compression, was 620 mAh. The ratio of the capacity density E1 to the capacity density F1: E1/F1, was 1.032.

A capacity (capacity density E2) per unit area of 1 cm² of the material mixture layer E, was 3.8 mAh. A capacity (capacity density F2) per unit area of 1 cm² of the material mixture layer E, was 3.8 mAh. Note that, herein, area means an area parallel to the main surface of the current collector. The ratio of the capacity density E2 to the capacity density F2: E2/F2, was 1.000.

Except for using the above negative electrode, an electrode assembly was assembled in the same manner as in Example 9.

A region X (region, with a radius of curvature of 3.0×10⁻³ m or less, of a cross section perpendicular to the winding axis, when the electrode assembly is assembled) in the negative electrode, was a region 10 mm in width, being along the longitudinal direction starting from an end portion of the negative electrode at the winding core side.

The ratio of the capacity density E1 to the capacity density F1: E1/F1, after winding of the negative electrode (after the electrode assembly was assembled), was 1.000.

Except for using the above electrode assembly, a battery was fabricated in the same manner as in Example 1.

### Example 11

Artificial graphite (tap density: 1.5 g/cm³), resulting from mixing at a 8:2 weight ratio: artificial graphite (negative electrode active material N_{A}) with an average particle size of 20 μm and an average degree of circularity of 0.95; and artificial graphite (negative electrode active material N_{B}) with an average particle size of 5 μm and an average degree of circularity of 0.95, was used as a negative electrode active material E (first negative electrode active material. Stirred with a double arm kneader, were SBR as a negative electrode binder, CMC as a thickener, and a proper amount of water, thereby preparing a negative electrode material mixture E (first material mixture) in slurry form. The weight ratio among the negative electrode active material E, the negative electrode binder, and CMC was 100:2.5:1.

Stirred with a double arm kneader, were: artificial graphite with an average particle size of 15 μm, an average degree of circularity of 0.95, and a tap density of 1.4 g/cm³, as a negative electrode active material F (second negative electrode active material); SBR as a negative electrode binder; CMC as a thickener; and a proper amount of water, thereby preparing a negative electrode material mixture E (second material mixture) in slurry form. The weight ratio among the negative electrode active material F, the negative electrode binder, and CMC was 100:2.5:1.

For a negative electrode current collector, a 10 μm-thick copper foil was prepared. The negative electrode material mixture E was applied to one surface of the negative electrode current collector, followed by drying, thereby forming a coating film E (thickness: 99 μm). The negative electrode material mixture F was applied to the other surface of the negative electrode current collector, followed by drying, thereby forming a coating film F (thickness: 101 μm). As such, a negative electrode precursor comprising the negative electrode current collector, the coating film E, and the coating film F was obtained.

The negative electrode precursor was compressed with a pair of rollers. That is, the coating film E and the coating film F were compressed, by allowing the same pressure (linear pressure: 40 N/cm) to be applied thereon, thereby forming a material mixture layer E (first material mixture layer) and a material mixture layer F (second material mixture layer), respectively. As such, a negative electrode was obtained. Thereafter, the negative electrode was cut to a size (measurement in longitudinal direction: 750 mm, measurement in width: 57 mm) capable of being inserted into a battery case of a cylindrical battery (18650 type).

The thickness of the material mixture layer E after compression was 83 μm. The thickness of the material mixture layer F after compression was 84 μm. A capacity (capacity density E1) per unit volume of 1 cm³ of the material mixture layer E after compression, was 650 mAh. A capacity (capacity density F1) per unit volume of 1 of the material mixture layer F after compression, was 640 mAh. The ratio of the capacity density E1 to the capacity density F1: E1/F1, was 1.015.

A capacity (capacity density E2) per unit area of 1 cm² of the material mixture layer E, was 3.8 mAh. A capacity (capacity density F2) per unit area of 1 cm² of the material mixture layer E, was 3.8 mAh. Note that, herein, area means an area parallel to the main surface of the current collector. The ratio of the capacity density E2 to the capacity density F2: E2/F2, was 1.000.

Except for using the above negative electrode, an electrode assembly was assembled in the same manner as in Example 9.

A region X (region, with a radius of curvature of 3.0×10⁻³ m or less, of a cross section perpendicular to the winding axis, when the electrode assembly is assembled) in the negative electrode, was a region 10 mm in width, being along the longitudinal direction starting from an end portion of the negative electrode at the winding core side.

The ratio of the capacity density E1 to the capacity density F1: E1/F1, after winding of the negative electrode (after the electrode assembly was assembled), was 0.986.

Except for using the above electrode assembly, a battery was fabricated in the same manner as in Example 1.

The respective batteries of Examples 9 to 11 were subjected to the same evaluation as above. Table 3 shows the results, together with the result of Comparative Example 1.

TABLE 3

| | E1/F1 | | |
|---|---|---|---|
| | When | When | |
| | electrode | electrode assembly | Capacity |
| | is produced | is assembled | retention |
| | (before winding of | (after winding of | rate |
| | electrode) | electrode) | (%) |
| Comp | 1.000 | 0.970 | 70 |
| Ex. 1 | | | |
| Ex. 9 | 1.015 | 0.986 | 78 |
| Ex. 10 | 1.032 | 1.000 | 83 |
| Ex. 11 | 1.015 | 0.986 | 80 |

The respective batteries of Examples 9 to 11, each in which E1/F1 after winding of the electrode exceeded 0.97 and was less than 1.03, exhibited more uniformity in electrode reactions and more improvement in charge/discharge cycle characteristics, compared to the battery of Comparative Example 1, in which E1/F1 after winding of the electrode was 0.97.

### Example 12

A battery was fabricated in the same manner as in Example 1, except for using the positive electrode of Example 6 and the negative electrode of Example 10. Table 4 shows the respective (first capacity density/second capacity density) values of when the electrode is produced and of when the electrode assembly is assembled, for the positive electrode and the negative electrode.

The battery of Example 12 was subjected to the same evaluation as above. Table 4 shows the results.

TABLE 4

| | | When | When | |
|---|---|---|---|---|
| | | electrode | electrode assembly | Capacity |
| | | is produced | is assembled | retention |
| | | (before winding | (after winding of | rate |
| | | of electrode) | electrode) | (%) |
| Ex. 12 | Positive | 1.031 | 1.000 | 89 |
| | electrode | | | |
| | (C1/D1) | | | |
| | Negative | 1.032 | 1.000 | |
| | electrode | | | |
| | (E1/F1) | | | |

Further, the battery of Example 12, in which both C1/D1 and E1/F1 were 1 when the electrode assembly was assembled, exhibited higher charge/discharge efficiency compared to the respective batteries of Examples 6 and 10.

From the above, it became evident that charge/discharge efficiency improves, whether the electrode of the present invention is used only for a positive electrode, used only for a negative electrode, or used for both the positive and negative electrodes.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

Since the secondary battery of the present invention has high capacity and is highly reliable, it is suitably used as respective power sources for: portable devices such as cell phones, digital cameras, and camcorders; electric vehicles; and hybrid vehicles.

1. An electrode used in a wound electrode assembly, said electrode comprising: a current collector; a first material mixture layer comprising a first active material, which is formed on one surface of said current collector; and a second material mixture layer comprising a second active material, which is formed on the other surface of said current collector,
wherein, when an electrode assembly is assembled, said first material mixture layer is wound in a manner such that said first material mixture layer is positioned on the outer side of said second material mixture layer, and
a capacity Cᵥ₁ per unit volume of said first material mixture layer is higher than a capacity Cᵥ₂ per unit volume of said second material mixture layer, in a part corresponding to a predetermined region of a cross section of said electrode assembly perpendicular to the winding axis thereof, the radius of curvature of said predetermined region being 3.0×10⁻³ m or less.

2. The electrode in accordance with claim 1, wherein, in said part corresponding to said predetermined region, the ratio of said capacity Cᵥ₁ per unit volume of said first material mixture layer to said capacity Cᵥ₂ per unit volume of said second material mixture layer: Cᵥ₁/Cᵥ₂, exceeds 1.01 and is 1.05 or less.

3. The electrode in accordance with claim 1, wherein, in said part corresponding to said predetermined region, the ratio of said capacity Cᵥ₁ per unit volume of said first material mixture layer to said capacity Cᵥ₂ per unit volume of said second material mixture layer: Cᵥ₁/Cᵥ₂, exceeds 1.01 and is 1.04 or less.

4. The electrode in accordance with claim 1, wherein, in said part corresponding to said predetermined region, the ratio of a capacity Cₐ₁ per unit area of said first material mixture layer to a capacity Cₐ₂ per unit area of said second material mixture layer: Cₐ₁/Cₐ₂, exceeds 0.97 and is less than 1.03.

5. The electrode in accordance with claim 1,
wherein said first material mixture layer and said second material mixture layer include a first binder and a second binder, respectively, and
said first binder has an elastic modulus lower than that of said second binder.

6. The electrode in accordance with claim 1, wherein said first active material has a filling ability higher than that of said second active material.

7. A secondary battery including a wound electrode assembly in which a pair of electrodes is wound with a separator therebetween,
wherein at least one in said pair of electrodes comprises: a current collector; a first material mixture layer comprising a first active material, which is formed on one surface of said current collector; and a second material mixture layer comprising a second active material, which is formed on the other surface of said current collector,
in said electrode assembly, said first material mixture layer is wound in a manner such that said first material mixture layer is positioned on the outer side of said second material mixture layer, and
the ratio of a capacity Cᵥ₁ per unit volume of said first material mixture layer to a capacity Cᵥ₂ per unit volume of said second material mixture layer: Cᵥ₁/Cᵥ₂, exceeds 0.97 and is less than 1.03, in a part corresponding to a predetermined region of a cross section of said electrode assembly perpendicular to the winding axis thereof, the radius of curvature of said predetermined region being 3.0×10⁻³ m or less.

8. The secondary battery in accordance with claim 7, wherein, in said electrode assembly, the ratio of said capacity Cᵥ₁ per unit volume of said first material mixture layer to said capacity Cᵥ₂ per unit volume of said second material mixture layer: Cᵥ₁/Cᵥ₂, is 0.98 or more and is 1.02 or less.

9. The secondary battery in accordance with claim 7, wherein, in said electrode assembly, the ratio of said capacity Cᵥ₁ per unit volume of said first material mixture layer to said capacity Cᵥ₂ per unit volume of said second material mixture layer: Cᵥ₁/Cᵥ₂, is 0.99 or more and is 1.01 or less.

10. The secondary battery in accordance with claim 7, wherein, in said electrode assembly, the ratio of said capacity Cᵥ₁ per unit volume of said first material mixture layer to said capacity Cᵥ₂ per unit volume of said second material mixture layer: Cᵥ₁/Cᵥ₂, is 1.00.

11. A method for fabricating a secondary battery, said method including the steps of:
(1) forming on one surface of a current collector, a first material mixture layer comprising a first active material and forming on the other surface of said current collector, a second material mixture layer comprising a second active material, thereby producing an electrode A having one polarity; and
(2) winding said electrode A and an electrode B having the other polarity, with a separator interposed therebetween, in a manner such that said first material mixture layer is positioned on the outer side of said second material mixture layer, thereby assembling an electrode assembly,
wherein, in said step (1), said electrode A is produced in a manner such that a capacity Cᵥ₁ per unit volume of said first material mixture layer is higher than a capacity Cᵥ₂ per unit volume of said second material mixture layer, in a part corresponding to a predetermined region of a cross section of said electrode group perpendicular to the winding axis thereof, the radius of curvature of said predetermined region being 3.0×10⁻³ m or less, and
in said step (2), said electrode assembly is assembled in a manner such that, in said predetermined region, the ratio of said capacity Cᵥ₁ per unit volume of said first material mixture layer to said capacity Cᵥ₂ per unit volume of said second material mixture layer: Cᵥ₁/Cᵥ₂, exceeds 0.97 and is less than 1.03.

12. The method for fabricating a secondary battery in accordance with claim 11, said step (1) comprising the steps of:
(a) applying to one surface of said current collector, a first material mixture including said first active material, followed by drying, thereby forming a first coating film;
(b) applying to the other surface of said current collector, a second material mixture including said second active material, followed by drying, thereby forming a second coating film; and
(c) compressing said first coating film and said second coating film by allowing the same pressure to be applied on said first coating film and said second coating film, thereby forming said first material mixture layer and said second material mixture layer, respectively,
wherein said first material mixture and said second material mixture include a first binder and a second binder, respectively,
said first binder has an elastic modulus lower than that of said second binder, and
in said step (c), said first coating film is compressed more than said second coating film.

13. The method for fabricating a secondary battery in accordance with claim 11, said step (1) comprising the steps of:
(A) applying to one surface of said current collector, a first material mixture including said first active material, followed by drying, thereby forming a first coating film;
(B) applying to the other surface of said current collector, a second material mixture including said second active material, followed by drying, thereby forming a second coating film; and
(C) compressing said first coating film and said second coating film by allowing the same pressure to be applied on said first coating film and said second coating film, thereby forming said first material mixture layer and said second material mixture layer, respectively,
wherein said first active material has a filling ability higher than that of said second active material, and
in said step (C), said first coating film is compressed more than said second coating film.
